(19) United States
(12) Patent Application Publication
(10) Pub. No.: US 2008/0020105 A1
(43) Pub. Date: Jan. 24, 2008

(54) Food Casing Based on Cellulose with an Impregnated Fibrous Material Reinforcement

(76) Inventors: Theresia Rieser, Eppelsheim (DE); Walter Lutz, Budenheim (DE)

Correspondence Address: PROPAT, L.L.C., 425-C SOUTH SHARON AMITY ROAD, CHARLOTTE, NC, 28211-2841, US

(21) Appl. No.: 11/587,838

(22) PCT Filed: May 6, 2005
(86) PCT No.: PCT/EP05/04918

§ 371 Date: Oct. 26, 2006

(30) Foreign Application Priority Data
May 10, 2004 (DE) 10 2004 022 974.0

(51) Int. Cl. A22C 13/00; B05D 1/36

(52) U.S. Cl. 426/129; 427/402; 428/34.8

(57) ABSTRACT

The invention relates to a tubular foodstuff casing based on regenerated or precipitated cellulose with a fiber reinforcement. This fiber reinforcement is impregnated and/or coated with at least one agent that regulates its adherence to a foodstuff located inside the casing.

The invention relates to a food casing based on regenerated cellulose with a fiber material insert. It relates in addition to the production of the casing and to its use as artificial sausage casing.

Synthetic skins based on regenerated cellulose that are reinforced with a fibrous paper strong when wet have long been part of the art (see G. Effenberger, Wursthüllen-Kunstdarm, Holzmann Buchverlag, Bad Wörishofen, 2^{nd} ed. [1991], pp. 23/24). The production of these casings, also referred to as fibrous skins, generally involves the use of a nonwoven fiber web, in particular a hemp fiber web. The requisite wet strength of the fiber web is achieved by treatment with dilute viscose solution (containing about 3% to 5% by weight cellulose), with cellulose acetate solution or with a polymeric liquor. The wet-strengthened fiber web is then cut into strips whose width corresponds to the caliber of the fibrous skins to be produced. In a fibrous-skin spinning machine the strips are each formed into a tube with an overlapping longitudinal seam, and this tube is then passed through an annular die with annular slit. Via the die, viscose is applied to the fiber-web tube from the outside, from the inside or from both sides. This viscose penetrates the fiber web. The externally, internally or doubly viscose-treated tube is then passed through acidic precipitating baths, in which the cellulose is regenerated from the viscose. Subsequently the tube passes additionally through washing baths, and possibly plasticizer baths as well, and is finally dried. In the finished tubular casing, the longitudinal edges of the fiber web are joined firmly to one another by the regenerated cellulose.

Even an externally viscose-treated tube has on its inside a substantially coherent layer of regenerated cellulose. Typically, in the case of externally viscose-treated fibrous skins, there is a virtually continuous layer of the regenerated cellulose on the inside. In comparison to cellulose hydrate skins without fiber reinforcement, fibrous skins in each case exhibit markedly improved caliber consistency and also a higher tensile strength.

Also known are fibrous skins which are produced by the amine oxide process. In that process, instead of the viscose solution, a solution of cellulose in a (hydrous) tertiary amine oxide is used. A particularly suitable solvent has proven to be N-methylmorpholine N-oxide, in particular its monohydrate. The cellulose is in purely physical solution in the amine oxide, without any chemical derivatization as in the viscose process. The coating of the fiber web material, formed into a tube, then takes place, using annular-slit dies, essentially as in the viscose process. Instead of the regeneration in acidic baths containing sulfuric acid, however, precipitation here takes place in a bath—frequently a chilled bath—of a dilute aqueous amine oxide.

There are already many fibrous skins known which have a subsequently applied impregnation or coating on the inside. This allows the meat adhesion to be adjusted to a desired level. The adhesion, for instance, is lessened by what are called peeling or release components, while it is increased by adhesive components. Cationic resins based on polyamine/polyamide/epichlorohydrin or on melamine/formaldehyde, for example, result in a significantly higher adhesion of the skin to the sausage meat. Also known are impregnations or coatings which contain both adhesive components and release components.

Thus EP-A 528 374 discloses a fiber-reinforced, tubular food casing based on cellulose hydrate, which is coated on the inside with chitosan. This improves the adhesion properties to a food present in the casing.

The cellulose fiber skin of EP-A 676 143 is impregnated on the inside with a mixture comprising a release component and an adhesive component, the ratio of adhesive component to release component being situated in the range from 4:1 to 1:4.

EP-A 1 042 958 relates likewise to a tubular food casing based on cellulose hydrate. This casing has been provided on the inside with a release preparation comprising a) a reactive hydrophobicizing component, b) a nonreactive hydrophobicizing component, and c) an oil and/or lecithin. It is therefore particularly amenable to easy peeling and hence is suitable even for high-protein and low-fat meat varieties, such as blood sausage or scalded-emulsion poultry sausage.

Besides the hemp fiber paper that is frequently used, fiber webs comprising a mixture of cellulose fibers and synthetic fibers have also been disclosed as a reinforcement for tubular food casings based on regenerated cellulose (WO 00/40092). These fiber webs are said to have the advantage that the stretch in the transverse direction on contact with moisture is more uniform over the width of the nonwoven web; in other words, the web does not stretch substantially more at the edges than in the middle.

Also known, finally, are tubular food casings based on cellulose hydrate which have a fiber paper web as their reinforcement, in combination with a textile material, such as a woven or knitted fabric made of wool, cotton, cellulose, polyamide, polyester, polyacrylonitrile or polypropylene (U.S. Pat. No. 5,043,194). The woven or knitted fabric forms a laminate, for example, together with the fiber paper web. As in the case of the fibrous skins already described, this laminate is in any case almost completely embedded in regenerated cellulose. In a further embodiment the textile material on its own forms the reinforcement. In this case the textile material is composed generally of cellulosic fibers, or alternatively of blends of cellulosic fibers with synthetic fibers. In general the layer of cellulose hydrate on the outside of the casings is kept sufficiently thin that the textile reinforcing material is still readily visible. In that case the casings have a particularly high-value effect. They are used in particular for dry or semi-dry (“long-keeping”) sausage varieties, such as salami.

The application of an impregnation or coating on the inside of the food casing for the purpose of adjusting the meat adhesion implies an additional process step, which, moreover, is relatively time-consuming and labor-intensive. The object, therefore, was to provide a tubular, fiber-reinforced food casing based on regenerated cellulose, which, without an additional internal impregnation or coating, has defined adhesion properties tailored to the particular food.

The object has been achieved with an impregnated or coated fiber reinforcement which possesses wet strength and which is not penetrated at all, or at least not completely, by the viscose solution, so that it still has contact with the food. It is then essentially the impregnation or coating on the fiber reinforcement that determines the adhesion of the casing to a food present therein. In all of the known fiber-reinforced casings based on cellulose hydrate, in contrast, the fiber reinforcement has served to enhance the mechanical stability, and also where appropriate to enhance the visual impression. It has had virtually no effect on the meat adhesion.

The present invention accordingly provides a tubular food casing based on regenerated or precipitated cellulose with a fiber reinforcement, wherein the fiber reinforcement is impregnated and/or coated with at least one agent which controls its adhesion to a food present in the casing.

The fiber reinforcement may be composed of natural or synthetic fibers or mixtures thereof. Natural fibers are, in particular, plant fibers, examples being those of hemp, abaca, sisal, jute, cotton or flax. Natural fibers can also be obtained, for example, from conifers. The term “natural fibers” is also intended here to embrace those fibers which are obtained by conversion of natural raw materials, examples being cellulose fibers, which are produced from cellulose, viscose fibers, fibers of cellulose esters or fibers of polylactides. Cellulose fibers can be obtained from spinnable cellulose solutions by the copper oxide ammonia process or the amine oxide process. Fibers of regenerated cellulose (viscose fibers) can be obtained by the known viscose process. Cellulose esters are obtainable for example by esterifying cellulose with C₁-C₄ monocarboxylic acids.

Synthetic fibers can be produced from plastics, which in turn are preparable by addition polymerization, polycondensation or polyaddition. The plastics are brought into a spinnable form by dissolution or melting and are spun using appropriate dies. Wet-spun fibers are consolidated in a precipitating bath, dry-spun fibers using air. The synthetic fibers may be composed for example of thermoplastics, such as of polyolefins (especially polyethylene or polypropylene) or copolymers with olefin units, polyesters (especially polyethylene terephthalate or polybutylene terephthalate) or copolyesters, aliphatic or (part-)aromatic polyamides or copolyamides (especially nylon-6, nylon 6,6, or nylon 6I/6T). Polyacrylate fibers (especially fibers of acrylonitrile or acrylonitrile copolymers having preferably vinyl acetate and/or vinyl-pyrrolidone as comonomer units) are typically spun from a polymer solution and consolidated by precipitation in a precipitating bath.

The polymer fibers may also be what are called bicomponent or multicomponent fibers (see Franz Fourné, Synthetische Fasern, Carl Hanser Verlag [1995], pp. 539-549). In the course of the production of these fibers, two or more different polymers are spun with one another in the same way. In this way it is possible to produce, for example, fibers having a polyester fraction and a polyamide fraction. The bicomponent or multicomponent fibers include, in particular, side-by-side types, core-sheath types, and matrix-fibril types. Different bicomponent or multicomponent fibers can be blended with one another or else with monocomponent fibers.

Preferred fiber reinforcements are those which comprise a mixture of natural and synthetic fibers. The fraction of the synthetic fibers in the mixture is for example 0.1% to 50% by weight, preferably 2% to 15% by weight, based in each case on the total weight of the (dry) fiber reinforcement (without the impregnation or coating).

The stated fibers form a sheetlike structure, in particular a nonwoven fiber web, a woven fabric or a loop-formed or loop-drawn knit. The nonwoven webs may in this case be produced from spun fibers or from filaments (referred to as continuous fibers). Within the web the fibers may have a preferential direction (oriented webs) or may be unoriented (random-laid webs). The webs can be produced mechanically, such as by needling, interlooping or entangling, for example, in which case it is also possible to use very fine, high-pressure waterjets (known under the headings of “spunlacing” or “hydroentanglement”). Within the web it is possible for the fibers to be held together by cohesive and/or adhesive forces. Adhesive consolidation comes about for example through chemical crosslinking of the fibers or by melting or dissolution of what are called binder fibers, which are mixed in during production of the web. Ultrasound consolidation is also possible. In the case of cohesive crosslinking, the surfaces of the fibers are incipiently dissolved using suitable chemicals and are joined by means of pressure. They can also be fused at an elevated temperature. Spunbonded webs can be obtained by spinning, subsequent laydown, followed by blow up or suspension of the fibers, known as spunbonding.

Spunbonding and spunlacing can also be combined. This makes it possible to obtain multilayer webs and/or multiphase webs. These may have different fiber materials and/or blends of different fibers within one layer or phase. Two-layer or two-phase webs can be obtained as well if a melt-spun web is introduced to start with and a further web is produced on it by melt spinning. In this way it is also possible to produce webs having an even greater number of layers and/or phases. It is likewise readily possible to apply wet-laid or dry-laid natural fibers to a melt-spun web of synthetic fibers, or vice versa. Finally, it is also possible to carry out subsequent adhesive or cohesive linking of webs of different chemical type to one another. The multilayer and/or multiphase webs generally have particularly advantageous properties, in particular a high porosity in conjunction with high strength and flexibility.

Particularly in the case of the webs made from or including natural fibers, the required web strength can be achieved or further improved by treatment with binders. For instance, fiber webs based on cellulose fibers which have been treated with a dilute viscose solution or with a dilute NMMO/cellulose solution have particular wet strength. In the case of binding using dilute viscose solution, the cellulose has to be regenerated from the viscose by treatment with acid. Examples of further agents which produce binding of the fibers in the web are polyamines, polyalkylenimines, proteins (which are preferably combined with crosslinkers), chitin, chitosan, alginate, cellulose ethers, polyvinyl alcohol or any desired mixtures thereof. Particularly preferred binders are polyamide/epichlorohydrin, polyamide/polyamine/epichlorohydrin, melamine/formaldehyde or polyvinylamine resins.

The dry weight of the fiber reinforcement, including any binder present, is generally 10 to 400 g/m², preferably 15 to 110 g/m². In the case of fiber webs the weight is advantageously in the lower section of the stated ranges, i.e., at about 10 to 35 g/m², preferably 15 to 30 g/m², more preferably 17 to 26 g/m². The weight of the textile fiber reinforcements is frequently somewhat above that of the fiber webs, i.e., at about 25 to 400 g/m², preferably 30 to 200 g/m².

The sheetlike fiber reinforcement, at least on the side that later comes into contact with the food, is then impregnated and/or coated with an agent which controls the adhesion to the food (referred to below as “adhesion control agent”). Depending on the nature of the agent and of the application method, it is possible to carry out coating or impregnation of the wet, partly dried or fully dried fiber reinforcement. The agent is preferably applied to the fiber reinforcement, consolidated where appropriate, by roller application or by spraying, or possibly by dipping. After treatment with the adhesion control agent, the fiber reinforcement is virtually impervious to the viscose to be applied subsequently. If the impregnated fiber reinforcement is formed to a tube and coated from the outside with the viscose, then following acid regeneration there is no cellulose hydrate layer, or at least no continuous layer, to be found on the inside. Advantageously, therefore, the adhesion control agent is applied only to the side of the sheetlike fiber material that later forms the inside of the tubular casing. In this case the viscose solution is still able to reach the outer regions of the fiber reinforcement relatively well, and to join the overlapping edges reliably with a join which has long-term mechanical load-bearing properties. A sheetlike fiber reinforcement which is attached only with wet strength, in contrast, is easily penetrated by the viscose solution.

Particularly suitable adhesion control agents are those which are attached chemically and/or physically to the surface of the fibers of the fiber reinforcement. By this is meant in particular that the agents are attached to the fibers by way of ionic bonds, hydrogen bonds and/or covalent bonds.

The adhesion control agents which raise the adhesion to a sausage meat filling include, for example, polyamide/epichlorohydrin, polyamide/polyamine/epichlorohydrin and melamine/formaldehyde resins, polyvinylamines (preferably those having an average molecular weight Mw of 10 000 to 1 000 000 daltons) and also copolymers containing vinylamine units (the comonomer units are preferably units of (meth)acrylic acid or (meth)acrylic acid derivatives, particularly of (meth)acrylic acid alkyl esters), polyvinylpyrrolidones (average Mw preferably more than 100 000 daltons), proteins, amylopectin, chitosan, deacetylated chitin, branched or unbranched polyalkylenimines. Proteins are combined where appropriate with crosslinkers, such as with dialdehydes (such as glyoxal or glutaraldehyde), dialdehyde derivatives, polyurethanes, aziridines, epoxides, polyamide-epichlorohydrin resins, polyamide-polyamine-epichlorohydrin resins or melamine/formaldehyde resins, for example, and also any desired mixtures thereof.

Agents which lessen the adhesion of the casing to the sausage meat are, in particular, diketenes having long, fatlike substituents (especially those with linear C₈-C₁₈ alkyl groups), chromium-fatty acid complexes, waxes (e.g., those based on ethylene/acrylic acid copolymers), crosslinkable silicones, polystyrene-based latices, copolymers containing styrene units (e.g., styrene/butadiene copolymers), polystyrene derivatives (such as carboxylated polystyrene), alginic acid and alginates, cellulose ethers (such as methylcellulose, hydroxyethylcellulose, hydroxypropylcellulose or carboxy-methylcellulose) or polyethylene oxides, and any desired mixtures thereof. The stated diketenes are generally dimers of ketenes of the formula RR′C═C═O, in which the radicals R and R′ are alike or different and stand for a hydrogen atom, a C₄-C₂₀ alkyl group, a C₄-C₂₀ cycloalkyl group, a C₆-C₂₀ aryl group or a C₆-C₂₀ aralkyl group, with the proviso that R and R′ do not simultaneously stand for a hydrogen atom. Where appropriate it is also possible for these agents to be in combination with crosslinkers already stated. Suitable adhesion reducers also include epoxidized oils, especially epoxidized linseed oil or soybean oil. Finally it is also possible to use polymers which have monomer units containing acid chloride groups or anhydride groups. These include, for example, copolymers of maleic anhydride, acrylic acid, and styrene or poly(meth)acryloyl chloride. Adhesion-raising and adhesion-reducing agents can also be combined.

The amount of the adhesion control agents to be applied is dependent on their chemical constitution and on their distribution on and/or in the fiber reinforcement. In general it is preferred not to distribute the agents uniformly in the fiber reinforcement but instead to keep them largely on the surface of the fiber reinforcement, as far as possible. In terms of order of magnitude, the amount of adhesion control agent(s) is about 50 to 3000 mg/m², preferably 75 to 2000 mg/m², more preferably 80 to 1200 mg/m², very preferably 100 to 1000 mg/m².

Adhesion control agents are applied advantageously in the form of an aqueous solution, dispersion or emulsion. Following their application, therefore, the material should be dried as well, using for example hot air, radiant heat, or with the aid of heated rollers or cylinders.

The sheetlike fiber reinforcement where appropriate may also be treated with further components. These include, for example, liquid smoke, flavors, biocides, latices, organic and/or inorganic particles (color pigment particles, for example), polyamide-based resins, oils or waxes. This embodiment is sensible in particular for absorbent fiber reinforcements, examples being those made of natural fibers.

The sheetlike fiber reinforcement thus pretreated is, where necessary, cut into strips of appropriate width which are brought into tube form (with the aid for example of what is called a forming shoulder). Then, in a skin-spinning machine, viscose solution is applied from the outside, in a manner known per se, to the tubes of the fiber material, and the cellulose is regenerated from the viscose. The process is controlled such that on the inside of the tubes there is no layer of regenerated cellulose formed, or at least no continuous layer. The impregnation or coating on the fiber reinforcement is then able later to control the adhesion of the casing to the foodstuff.

The viscose solution used for coating may further comprise polymeric additives, examples being alginates, polyvinylpyrrolidone, copolymers of N-vinylpyrrolidone and dimethylaminomethyl methacrylate, or copolymers of N-vinylpyrrolidone and trimethylmethacryloyloxyalkylammonium halide, alkanesulfonate or sulfate, polyethylene oxides, which act simultaneously as primary plasticizers in the finished casing. The fraction of polymeric additives may range up to about 40% by weight, based on the weight of the cellulose in the viscose solution. By this means it is possible to modify the properties still further.

The impregnated and/or coated sheetlike fiber reinforcement can also be coated as a flat product with viscose. Following the regeneration of the cellulose, the coated material is then cut into strips of appropriate width, the strips are shaped to a tube with overlapping edges, and the edges are then permanently fixed. Fixing can be accomplished by means for example of adhesive bonding or stitching. Here as well it should be ensured that the side of the flat product that later on faces the food has no regenerated cellulose layer, or at least no continuous regenerated cellulose layer.

The fibrous skin based on cellulose hydrate can additionally be provided on the outside with a continuous coating which has barrier properties for water vapor and/or oxygen. An effective water-vapor and oxygen barrier can be achieved for example with an external polyvinylidene chloride (PVDC) coating.

The food of the invention itself may likewise be treated with liquid smoke, flavors, biocidal substances or similar typical additives.

The food casings of the invention can be used with preference as artificial sausage casings, as in the production of raw-meat sausage, scalded-emulsion sausage or cooked-meat sausage, for example. They can also be used in the production of cheese.

The examples which follow serve to illustrate the invention. Percentages in these examples are by weight, unless indicated otherwise or directly apparent from the context.

All the casings are coated from the outside on one side with viscose by the viscose process after the fibrous or textile sheetlike structures had been formed into a tube. The cellulose is regenerated using dilute sulfuric acid. Subsequently the gel tube is neutralized, provided with a plasticizer, and dried. In the examples, the modified sides of the fibrous or textile sheetlike structures are on the inside of the food casings which have been formed to a tube. From the sheetlike fiber reinforcements, webs with a paper width of 202 mm are cut, which are suitable for the production of a sausage casing having a caliber of 60.

### EXAMPLE 1 (COMPARATIVE EXAMPLE)

As a comparison to the fiber-reinforced cellulose casings with modified nonwoven web, a casing was used which had a nonwoven web reinforcement possessing wet strength, in which the fibers were composed to an extent of 96% of cellulose fibers and to an extent of 4% of polyethylene terephthalate fibers, and which had a basis weight of 19 g/m². The web had been wet-strengthened by impregnation with a customary polyamide/polyamine/epichlorohydrin-based resin binder. The proportion of the binder was 2% of the total weight of the web. Using the viscose process, a fiber-reinforced, cellulose-based food casing having a basis weight of approximately 74 g/m² was manufactured using this web.

### EXAMPLE 2

A web possessing wet strength, with a fraction of 96% cellulose fibers and 4% polyethylene terephthalate fibers and a basis weight of 19 g/m², was coated on one side by roll application, after drying, with a commercially available polyvinylamine (Luresin PR 8086, BASF AG) and then dried again. The wet strength of the web was produced by a customary polyamide/polyamine/epichlorohydrin-based resin binder which was mixed into the web at 2%. The coating solution contained about 25% of polyvinylamine. The amount of the polyvinylamine applied was 1000 mg/m². Using the viscose process, the web was used to manufacture a fiber-reinforced, cellulose-based food casing having a basis weight of 74 g/m².

### EXAMPLE 3

A web of 96% cellulose fibers and 4% polyethylene terephthalate fibers was treated with a dilute viscose solution. The cellulose was then regenerated from the viscose using dilute sulfuric acid. The regenerated cellulose gave the web wet strength. The regenerated cellulose had a fraction of about 5%, based on the dry weight of the web strong when wet, which was approximately 19 g/m². Subsequently a commercially available polyvinylamine (Luresin PR 8086, BASF AG) was applied by roll application to one side of the web. The product thus treated was then dried again. The coating solution contained about 25% of polyvinylamine. The amount of the polyvinylamine applied was 1000 mg/m². Using the viscose process, the web was used to manufacture a fiber-reinforced, cellulose-based food casing having a basis weight of 75 g/m².

### EXAMPLE 4

A web possessing wet strength, with a fraction of 96% cellulose fibers and 4% polyethylene terephthalate fibers and a basis weight of 19 g/m², was coated on one side by roll application, after drying, with a commercially available chromium-fatty acid complex solution (®Montacell CF, H. Costenoble GmbH & Co. KG) and then dried again. The wet strength of the web was achieved by treating the wet-laid webs with viscose and regenerating the cellulose using dilute sulfuric acid solution. The amount of the chromium-fatty acid complex applied was 800 mg/m². Using the viscose process, the web was used to manufacture a fiber-reinforced, cellulose-based food casing having a basis weight of 74 g/m².

### EXAMPLE 5 (COMPARATIVE EXAMPLE)

A woven fabric in web form 202 mm wide, composed of 100% cellulose, with a basis weight of 60 g/m² was used for producing a fabric-reinforced, tubular, cellulose-based food casing. This was done using the viscose process. The basis weight of the finished casing was 120 g/m².

### EXAMPLE 6

Applied to one side of a woven fabric in web form with a width of 202 mm, consisting of 100% cellulose and having a basis weight of 60 g/m², was a polyvinylamine coating (Luresin PR 8086, BASF AG), application taking place by roller. The fabric was dried and used for producing a fabric-reinforced, tubular, cellulose-based food casing. The amount of polyvinylamine applied was 1000 mg/m². This was done using the viscose process. The basis weight of the finished casing was 120 g/m².

### EXAMPLE 7

Applied to one side of a woven fabric in web form with a width of 202 mm, consisting of 100% cellulose and having a basis weight of 60 g/m², was a chromium-fatty acid complex (®Montacell CF), application taking place by roller. The fabric was dried and used for producing a fabric-reinforced, tubular, cellulose-based food casing. The amount of chromium-fatty acid complex applied was 800 mg/m². This was done using the viscose process. The basis weight of the finished casing was about 120 g/m².

Stuffing Tests

The food casings of the invention were tested in comparison to a food casing reinforced with conventional fibrous or textile sheetlike structures. A scale of ratings was determined that characterizes the adhesion of the casing to the meat. Table 1 shows an overview of the rating scale with the associated adhesion properties.

TABLE 1
Scale of ratings for the adhesion properties of the casings

| | | very | | moderately | | very |
|---|---|---|---|---|---|---|
| | no | slight | slight | strong | strong | strong |
| | adhesion | adhesion | adhesion | adhesion | adhesion | adhesion |
| Rating | 0 | 0.5 | 1 | 1.5-1.75 | 2.0-2.25 | 2.5 |

Raw Sausage Production

A meat emulsion was used which consisted of 70% meat from the shoulder of the pig and 30% fat (back fat from the pig), which had been stored at −30° C., and also 24 g/kg nitrite curing salt. The water activity (a_{w}) was 0.98-0.99. The pH was 6.0 (measured 24 h after slaughter). The ingredients were comminuted at −5 to 0° C. (pH up to 5.9; a_{w} 0.96 to 0.97). The casing was stuffed at a temperature of −3 to +1° C. Ripening took place after an equilibration time of approximately 6 h at a temperature of 20 to 25° C. and a relative atmospheric humidity of below 60% in three sections in a dark room. The ripening sections are shown in table 2.

TABLE 2
Summary of the ripening sections in raw sausage ripening

| Ripening | | Section 1 | Section 2 | Section 3 |
|---|---|---|---|---|
| Room | temperature | 18 to 25° C. | 18 to 22° C. | around 15° C. |
| | rel. humidity | 90 to 92% | 85 to 90% | 75 to 80% |
| | air velocity | 0.5 to 0.8 | 0.2 to 0.5 | 0.05 to 0.1 |
| | [m/sec] | | | |
| Product | pH | 5.2 to 5.6 | 4.8 to 5.2 | 5.0 to 5.6 |
| | a_{w} | 0.94 to 0.96 | 0.90 to 0.94 | 0.85 to 0.92 |
| | ripening time | 3 days | 7 days | 6 weeks |

Scalded-Emulsion/Cooked-Meat Sausage Production

To produce meat sausage the stuffed skin was heated at 75° C. The heating time was calculated in minutes in accordance with the caliber employed +10% extra time. For a food casing with a caliber of 60, for example, this meant that the scalded-emulsion sausage was cooked for 60 min+6 min.

The peel results in table 3 show very clearly the effect of the nonwoven-web coating on the adhesion of the food casing to the contents. The polyvinylamine coating promotes, and the chromium-fatty acid coating lessens, the adhesion of the casing to the sausage meat in comparison to the examples not produced using modified nonwoven webs. Particularly in the case of the casings with the adhesion coating it is possible by virtue of the additional coating to generate a strong adhesion which is stable for several weeks. The casing of the comparative example had a level of adhesion which, although moderately strong after 10 days, fell off drastically after a 6-week ripening period. The examples with meat sausage likewise showed that the nonwoven-web coating determines the adhesion of the casing to the meat (table 4).

TABLE 3
Peeling results after 10 days and 6 weeks with salami

| Examples | Peel rating after 10 days | Peel rating after 6 weeks |
|---|---|---|
| 1 | 1-1.5 | 0.5-1 |
| 2 | 2.25 | 2 |
| 3 | 2.25 | 2 |
| 4 | 0-0.5 | 0 |
| 5 | 1-1.5 | 0.5-1 |
| 6 | 2 | 2 |
| 7 | 0-0.5 | 0 |

TABLE 4
Peeling results with meat sausage 1 day after cooking

| Examples | Peel rating |
|---|---|
| 1 | 1.5 |
| 2 | 2.0-2.25 |
| 3 | 2.0-2.25 |
| 4 | 0.5-1.0 |
| 5 | 1.5 |
| 6 | 2.0-2.25 |
| 7 | 0.5-1.0 |

1. A tubular food casing comprising regenerated or precipitated cellulose with a fiber reinforcement, wherein the fiber reinforcement is impregnated and/or coated with at least one agent which controls adhesion between said food casing and a food present in the casing.

2. The food casing of claim 1, wherein the fiber reinforcement is comprised of natural or synthetic fibers or mixtures thereof.

3. The food casing of claim 2, wherein the natural fibers are plant fibers or are fibers obtained by conversion of natural raw materials.

4. The food casing of claim 2, wherein the synthetic fibers are produced from plastics obtainable by addition polymerization, polycondensation or polyaddition.

5. The food casing of claim 4, wherein the fibers are comprised of thermoplastics.

6. The food casing of claim 1, wherein the fiber reinforcement comprises a mixture of natural and synthetic fibers.

7. The food casing of claim 6, wherein the fraction of the synthetic fibers in the mixture is 0.1% to 50% by weight, based on the total weight of the dry fiber reinforcement before it is impregnated or coated.

8. The food casing of claim 2, wherein the fibers form a sheetlike structure.

9. The food casing of claim 8, wherein the sheetlike structure is a nonwoven fiber web and the nonwoven fiber web is produced from spun fibers or filaments and its fibers may have a preferential direction or may be unoriented.

10. The food casing of claim 1, wherein the amount of the adhesion control agent is 50 to 3000 mg/m².

11. A process for producing the food casing of claim 1, which comprises the following steps:
a) providing a sheetlike fiber reinforcement,
b) impregnating and/or coating the sheetlike fiber reinforcement with at least one agent which controls the adhesion to a food present in the casing,
c) forming the impregnated and/or coated sheetlike fiber reinforcement to a tube,
d) coating the outside of the tube obtained in c) with viscose solution, and
e) coagulating and regenerating the viscose to cellulose hydrate.

12. The process of claim 11, wherein the sheetlike fiber reinforcement is coated and/or impregnated with an adhesion control agent only on the side which faces the food after the casing has been filled.

13. The process of claim 11, wherein the impregnation or coating is applied by roller application, with the aid of a doctor blade, or by spraying.

14. An artificial sausage casing or cheese casing comprising the food casing of claim 1.

15. The food casing of claim 3, wherein the plant fibers are hemp, abaca, sisal, jute, cotton or flax and the fibers obtained by conversion of natural raw materials are cellulose, cellulose ethers, polylactides or viscose fibers.

16. The food casing of claim 5, wherein the thermoplastics are polyolefins, copolymers with olefin units, polyesters, copolyesters, aliphatic or (part-)aromatic polyamides or copolyamides.

17. The food casing of claim 7, wherein the fraction of the synthetic fibers is 2 to 15% by weight.

18. The food casing of claim 8, wherein the sheetlike structure is a nonwoven fiber web, a woven fabric, a loop-formed knit or a loop-drawn knit.

19. The food casing of claim 1, wherein the amount of the adhesion control agent is 75 to 2000 mg/m².

20. The artificial sausage casing or cheese casing of claim 14, wherein the sausage is selected from raw-meat sausage, cooked-meat sausage or scalded-emulsion sausage.
